(19) United States
(12) Patent Application Publication
(10) Pub. No.: US 2011/0129012 A1
(43) Pub. Date: Jun. 2, 2011

(54) Video Data Compression

(76) Inventor: Erik Erland Erlandson, Roseville, CA (US)

(21) Appl. No.: 13/022,784

(22) Filed: Feb. 8, 2011

Related U.S. Application Data
(62) Division of application No. 11/218,040, filed on Aug. 31, 2005.

(51) Int. Cl. H04N 11/04

(52) U.S. Cl. 375/240.01; 375/E07.026

(57) ABSTRACT

An image encoder includes a processor operable to define a first viewable region within an image at a first viewing time, and generate data representing the image and a location of the first viewable region within the image.

### BACKGROUND

To electronically transmit relatively high-resolution video images over a relatively low-bandwidth channel, or to electronically store such images in a relatively small memory space, it is often necessary to compress the digital data that represents the images. Such video image compression typically involves reducing the number of data bits necessary to represent an image.

Referring to FIGS. 1A-2, the Moving Pictures Experts Group (MPEG) compression standards, which include MPEG-1 and MPEG-2, are discussed. The MPEG formats are block-based compression formats that divide a video image into blocks and then utilize discrete cosine transform (DCT) compression to sample the image at regular intervals, analyze the frequency components present in the sample, and discard those frequencies which do not affect the image as the human eye perceives it. For purposes of illustration, the discussion is based on using an MPEG 4:2:0 format to compress video images represented in a Y, C_{B}, C_{R} color space.

Referring to FIG. 1A, each video image, or frame, is divided into subregions called macro blocks, which each include one or more pixels. FIG. 1A is a 16-pixel-by-16-pixel macro block 10 having 256 pixels 12 (not drawn to scale). In the MPEG standards, a macro block is 16×16 pixels, although other compression standards may use macro blocks having other dimensions. In the original video frame, i.e., the frame before compression, each pixel 12 has a respective luminance value Y and a respective pair of chroma-difference values C_{B} and C_{R}.

Referring to FIGS. 1A-1D, before compression of the frame, the digital luminance (Y) and chroma-difference (C_{B} and C_{R}) values that will be used for compression are generated from the original Y, C_{B} and C_{R} values of the original frame. In the MPEG 4:2:0 format, the pre-compression Y values are the same as the original Y values. Thus, each pixel 12 merely retains its original luminance value Y. But to reduce the amount of data to be compressed, the MPEG 4:2:0 format allows only one pre-compression C_{B} value and one pre-compression C_{R} value for each group 14 of four pixels 12. Each of these pre-compression C_{B} and C_{R} values are respectively derived from the original C_{B} and C_{R} values of the four pixels 12 in the respective group 14. For example, a pre-compression C_{B} value may equal the average of the original C_{B} values of the four pixels 12 in the respective group 14. Thus, referring to FIGS. 1B-1D, the pre-compression Y, C_{B} and C_{R} values generated for the macro block 10 are arranged as one 16×16 matrix 16 of pre-compression Y values, one 8×8 matrix 18 of pre-compression C_{B} values, and one 8×8 matrix 20 of pre-compression C_{R} values. The matrices 16, 18 and 20 are often called “blocks” of values. Furthermore, because it is convenient to perform the compression transforms on 8×8 blocks of pixel values instead of on 16×16 blocks, the block 16 of pre-compression Y values is subdivided into four 8×8 blocks 22a-22d, which respectively correspond to the 8×8 blocks A-D of pixels in the macro block 10. Thus, referring to FIGS. 1A-1D, six 8×8 blocks of pre-compression pixel data are generated for each macro block 10: four 8×8 blocks 22a-22d of pre-compression Y values, one 8×8 block 18 of pre-compression C_{B} values, and one 8×8 block 20 of pre-compression C_{R} values.

An MPEG compressor, or encoder, converts the pre-compression data for a frame or sequence of frames into encoded data that represent the same frame or frames with significantly fewer data bits than the pre-compression data. To perform this conversion, the encoder reduces redundancies in the pre-compression data and reformats the remaining data using DCT and coding techniques.

More specifically, the encoder receives the pre-compression data for a sequence of one or more frames and reorders the frames in an appropriate sequence for encoding. Thus, the reordered sequence is often different than the sequence in which the frames are generated and will be displayed. The encoder assigns each of the stored frames to a respective group, called a Group Of Pictures (GOP), and labels each frame as either an intra (I) frame or a non-intra (non-I) frame. The encoder always encodes an I frame without reference to another frame, but can and often does encode a non-I frame with reference to one or more of the other frames in the same GOP. If an I frame is used as a reference for one or more non-I frames in the GOP, then the I frame is encoded as a reference frame.

During the encoding of a non-I frame, the encoder initially encodes each macro block of the non-I frame in at least two ways: in the same manner as for I frames, or using motion prediction, which is discussed below. This technique ensures that the macro blocks of the non-I frames are encoded using a fewer number of bits.

With respect to motion prediction, a macro block of pixels in a frame exhibits motion if its relative position changes in the preceding or succeeding frames. Generally, succeeding frames contain at least some of the same macro blocks as the preceding frames. But such matching macro blocks in a succeeding frame often occupy respective frame locations that are different than the respective frame locations they occupy in the preceding frames. Alternatively, a macro block may occupy the same frame location in each of a succession of frames, and thus exhibit “zero motion.” In either case, instead of encoding each frame independently, it often takes fewer data bits to tell a decoder “the macro blocks R and Z of frame 1 (non-I frame) are the same as the macro blocks that are in locations S and T, respectively, of frame 0 (reference frame).” This “statement” is encoded as a motion vector.

FIG. 2 illustrates the concept of motion vectors with reference to the non-I frame 1 and the reference frame 0 discussed above. A motion vector MV_{R} indicates that a match for the macro block in the location R of frame 1 can be found in the location S of reference frame 0. MV_{R} has three components. The first component, here 0, indicates the frame (here frame 0) in which the matching macro block can be found. The next two components, X_{R} and Y_{R}, together comprise the two-dimensional location value that indicates where in the frame 0 the matching macro block is located. Thus, in this example, because the location S of the frame 0 has the same X-Y coordinates as the location R in the frame 1, X_{R}=Y_{R}=0. Conversely, the macro block in the location T matches the macro block in the location Z, which has different X-Y coordinates than the location T. Therefore, X_{z} and Y_{z} represent the location T with respect to the location Z. For example, suppose that the location T is ten pixels to the left of (negative X direction) and two pixels down from (negative Y direction) the location Z. Therefore, MV_{z}=(0, −10, −2). Although there are many other motion vector schemes available, they are all based on the same general concept.

Although MPEG formats and other block-based encoding techniques are capable of high compression rates with little loss of discernable quality, they all have inherent limitations that prevent them from achieving even greater data volume reduction. Because block-based encoding techniques simply divide video images into 16-pixel-by-16-pixel macro blocks, they are not only limited to making decisions one macro block at a time, but they are also limited to compressing data one macro block at a time. Accordingly, there is a need for a video image encoding technique that overcomes these and other limitations of block-based encoding techniques.

### SUMMARY

An embodiment of the present invention is an image encoder including a processor operable to define a first viewable region within an image at a first viewing time, and generate data representing the image and a location of the first viewable region within the image.

### BRIEF DESCRIPTION OF THE DRAWINGS

FIG. 1A is a diagram of a conventional macro block of pixels in an image.

FIG. 1B is a diagram of a conventional block of pre-compression luminance values that respectively correspond to the pixels in the macro block of FIG. 1A.

FIGS. 1C and 1D are diagrams of conventional blocks of pre-compression chroma values that respectively correspond to the pixel groups in the macro block of FIG. 1A.

FIG. 2 illustrates the concept of conventional motion vectors.

FIG. 3 illustrates the concept of using image objects for motion prediction according to an embodiment of the invention.

FIG. 4 illustrates the concept of patterns of motion for image objects according to an embodiment of the invention.

FIG. 5 illustrates the concept of panoramic frames according to an embodiment of the invention.

FIG. 6 illustrates the concept of scene repetition according to an embodiment of the invention.

FIG. 7 is a block diagram of a system according to an embodiment of the invention.

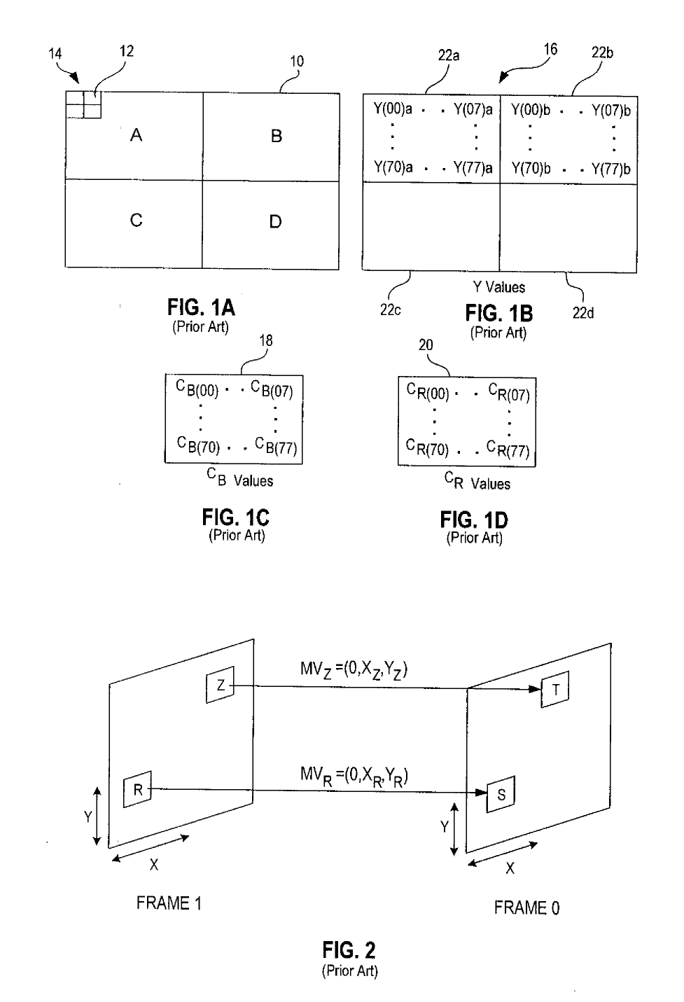

### DETAILED DESCRIPTION

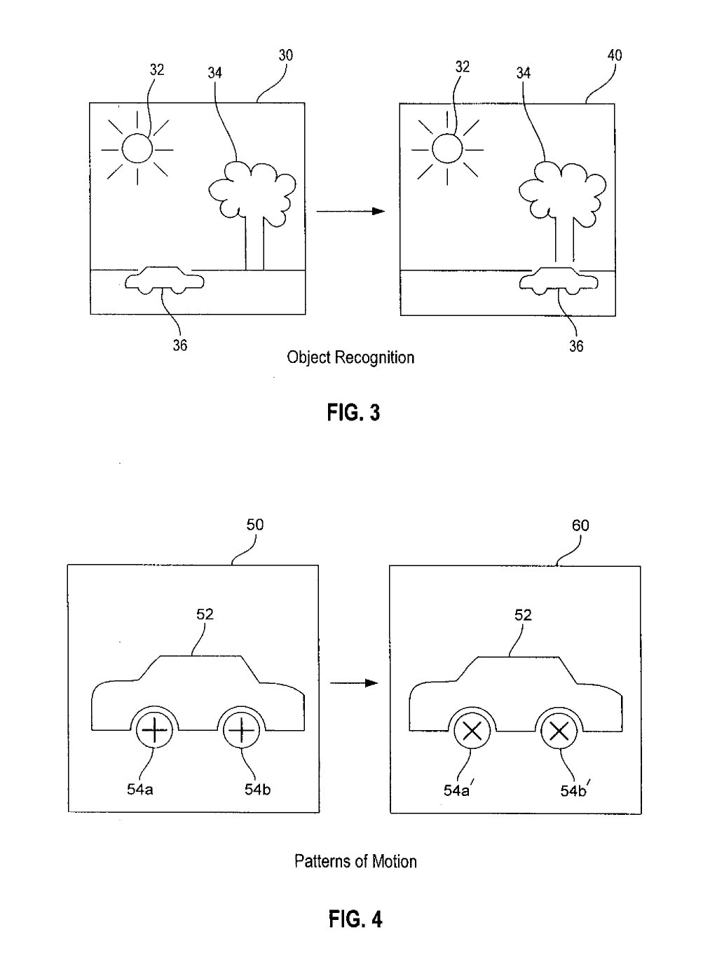

FIG. 3 illustrates the concept of using image objects for motion prediction according to an embodiment of the invention. For purposes of illustration, the example discussed is based on an image encoder/transmitter that captures a frame of pixel data representing a video image 30 and utilizes an MPEG format similar to that discussed above in the Background. However, the transmitter may also utilize any other type of compression format, or none at all.

After capturing a first frame of pixel data representing a first image 30, the transmitter uses optical character recognition (OCR) algorithms to identify visual objects 32, 34, 36 within the image 30. For example, the OCR algorithms may be based on edge detection that recognizes contrast changes within the image. In this way the transmitter is able to detect the edges or the edge contours of a sun 32, a tree 34 and an automobile 36.

Once the objects 32, 34, 36 have been detected, the transmitter stores each object in a memory or object buffer. The transmitter also generates and stores data corresponding to each object, including the content of the object, the orientation of the object, and the location of the object within the image. The objects 32, 34, 36 and their corresponding data may be retrieved later for use in subsequent images captured by the transmitter. Although the total number of objects stored in the object buffer may be limited by the memory capacity of the object buffer, each object may be given a priority based on how frequently and how recently the object was retrieved. That way when the memory capacity of the object buffer is exceeded, the objects with the least priority are dropped.

After storing the objects 32, 34, 36 in the object buffer, the transmitter encodes the entire image 30 in a standard MPEG format to create a reference frame, and sends the encoded reference frame to a receiver. In addition, the transmitter also sends the data corresponding to the objects 32, 34, 36 to the receiver.

The receiver then decodes the reference frame to recover the original image 30. The receiver then uses the data corresponding to the objects 32, 34, 36 to locate and extract the objects 32, 34, 36 from the image 30, and store the objects 32, 34, 36 in an object buffer similar to the one in the transmitter.

When the transmitter captures a second frame of pixel data representing a second image 40, the transmitter uses OCR algorithms to identify visual objects 32, 34, 36 within the image 40. At this point, the transmitter compares the detected objects from the second image 40 with the objects already stored in the object buffer. If there is no match, each new object is also stored in the object buffer. But in this example, the objects 32, 34, 36 within the image 40 match the same objects 32, 34, 36 already stored in the object buffer. As a result, the transmitter does not need to store the objects 32, 34, 36 in the object buffer again.

The transmitter also compares the data corresponding to the objects 32, 34, 36 in the image 40 with the stored data corresponding to the same objects in the image 30. For example, because the locations of the sun 32 and the tree 34 have not changed between the images 30 and 40, the transmitter determines that the sun 32 and the tree 34 are stationary objects. However, because the location of the automobile 36 has changed between the images 30 and 40, the transmitter determines that the automobile 36 is a moving object and sends a motion vector associated with the automobile 36 to the receiver. This allows the receiver to know the new position of the automobile 36 within the image 40.

In this way, the transmitter does not have to re-send the objects 32, 34, 36 to the receiver. When the image 40 is encoded, the transmitter does not encode the objects 32, 34, 36 but only encodes the remaining portion of the image 40. In the portions of the image 40 where the objects 32, 34, 36 are located, the transmitter simply sends a “no value” for those portions to the receiver, thus saving a significant amount of transmission data and reducing the bandwidth between the transmitter and the receiver.

The receiver then receives and decodes the encoded portion of the image 40. Because the objects 32, 34, 36 are already stored in the receiver's object buffer, the receiver retrieves the objects 32, 34, 36 from its object buffer and inserts them in their respective locations within the image 40 indicated by their respective motion vectors. This is similar to the concept of motion vectors with macro blocks, but here it is done on a much larger scale because each object is typically equivalent in size to many macro blocks. Furthermore, because each object is stored in an object buffer, the objects are not dependent on a GOP structure.

Alternatively, the transmitter and receiver may use the location data corresponding to each object to eliminate the use of motion vectors altogether. Whenever the transmitter captures a frame of pixel data representing an image, instead of comparing the location data of each object in the current image to the previous image to determine a motion vector, the transmitter may simply send the location data of each object to the receiver for every image. The receiver may then use the location data of each object to insert the objects in the appropriate location for every image without having to reference a previous location of the object.

The content data corresponding to each object may be used by the transmitter and the receiver to take into account differences in content of an object from image to image. The transmitter may determine slight differences in an object from image to image and encode these differences as residuals on a per block basis within the object, or in some other manner. In this way, the transmitter only needs to send the residuals to the receiver instead of the entire object. Then the receiver decodes the residuals and applies them to the objects retrieved from the receiver's object buffer. For example, the automobile 36 in the image 40 may have slightly different reflections and shadows than it has in the image 30. These differences in the content of the automobile 36 may be encoded by the transmitter as residuals and sent to the receiver. The receiver then decodes the residuals, retrieves the automobile 36 from its object buffer, and applies the residuals to the appropriate portions of the automobile 36 that are different in the image 40.

Also, the content data corresponding to an object may be used by the transmitter and the receiver to update the object from image to image. The transmitter may determine that new portions are being added to an object from image to image, and add the new portions to the object and store the updated object in the object buffer. The transmitter then encodes these new portions on a per block basis, or in some other manner. In this way, the transmitter only needs to send the new portions of the object to the receiver instead of the entire object. Then the receiver decodes the new portions of the object, adds them to the object retrieved from the receiver's object buffer, and stores the updated object in the object buffer. For example, the automobile 36 may be entering an image from left to right. Suppose in the image 30, only the front bumper of the automobile 36 is visible at the left edge of the image. As the automobile 36 moves from left to right, more of the automobile 36 becomes visible in the image 40. These new portions (e.g., the front wheel and hood) of the automobile 36 are added to the bumper and the updated automobile 36 is stored in the transmitter's object buffer. The new portions of the automobile 36 may be encoded by the transmitter and sent to the receiver. The receiver then decodes the new portions, retrieves the bumper of the automobile 36 from its object buffer, adds the new portions to the bumper, and stores the updated automobile 36 in the receiver's object buffer.

In addition, the transmitter may divide a larger object into sub-objects or object sections. This may be advantageous if one of the object sections changes from image to image more frequently than the other object sections. In this way, the transmitter can limit the encoding and transmission of data to only the object section requiring change instead of the entire object. For example, instead of treating the automobile 36 as a single object, the transmitter may treat the bumper, the wheels, the doors, etc. as separate objects.

It should be noted that the concept described above assumes that the range of focus of the camera stays relatively stable. This is because telephoto effects, such as zooming in and out, would result in blooming or shrinking of the image. This would cause the objects of the image to change in size and detail. In this case, the image may be stored in multiple layers, where each layer of the image corresponds to a different telephoto focal length. Then the OCR algorithms may be applied to each focal length layer.

FIG. 4 illustrates the concept of patterns of motion for image objects according to an embodiment of the invention. In some images, an object may exhibit relative motion with respect to the object itself. This can also be characterized as a change in the object's orientation. The transmitter and receiver may use the orientation data corresponding to each object to take into account changes in the object's orientation from image to image.

After detecting an automobile 52 and wheels 54 in a third image 50, the transmitter stores each object and its orientation data in the transmitter's object buffer. The orientation data of each object may include a position or orientation vector, or any other indicator of orientation within the image. The transmitter encodes the automobile 52 and the wheels 54, and sends the encoded objects and their orientation data to the receiver. The receiver then decodes the automobile 52 and the wheels 54, and stores the objects and their orientation data in the receiver's object buffer.

When the transmitter detects the automobile 52 and the wheels 54′ in a fourth image 60, the transmitter compares the orientation data of the objects in the fourth image 60 to the orientation data of the objects already stored in the transmitter's memory buffer from the third image 50. For example, neither the location nor the orientation of the automobile 52 has changed between the images 50 and 60. Similarly, the locations of the wheels 54 and 54′ have not changed between the images 50 and 60. However, because the wheels 54 and 54′ have undergone a rotation between the images 50 and 60, the orientation of the wheels 54 have changed. As a result, the transmitter stores the wheels 54′ and their new orientation in the object buffer, encodes the wheels 54′, and sends the encoded wheels 54′ and their orientation data to the receiver. The receiver then decodes the wheels 54′ and stores them and their orientation data in the receiver's object buffer.

This process is repeated for every subsequent image in which the wheels 54′ undergo a further change in orientation until a pattern of motion is detected by the transmitter. In this example, when the transmitter again detects the same orientation of the wheels 54 from the third image 50, the pattern of motion is complete because the wheels 54 have completed one full rotation. When this occurs, the transmitter no longer needs to store, encode and transmit an entirely new wheel for every image. Instead, the transmitter only needs to send a signal instructing the receiver to repeat the sequence of wheels already stored in the receiver's object buffer. This signal may simply be a position vector that tells the receiver which position the wheel is in and thus which version of the wheel to display in that particular image. In addition, the sequence of wheels, or any other pattern of motion, may be stored as a motion algorithm in the receiver's object buffer or in an algorithm buffer.

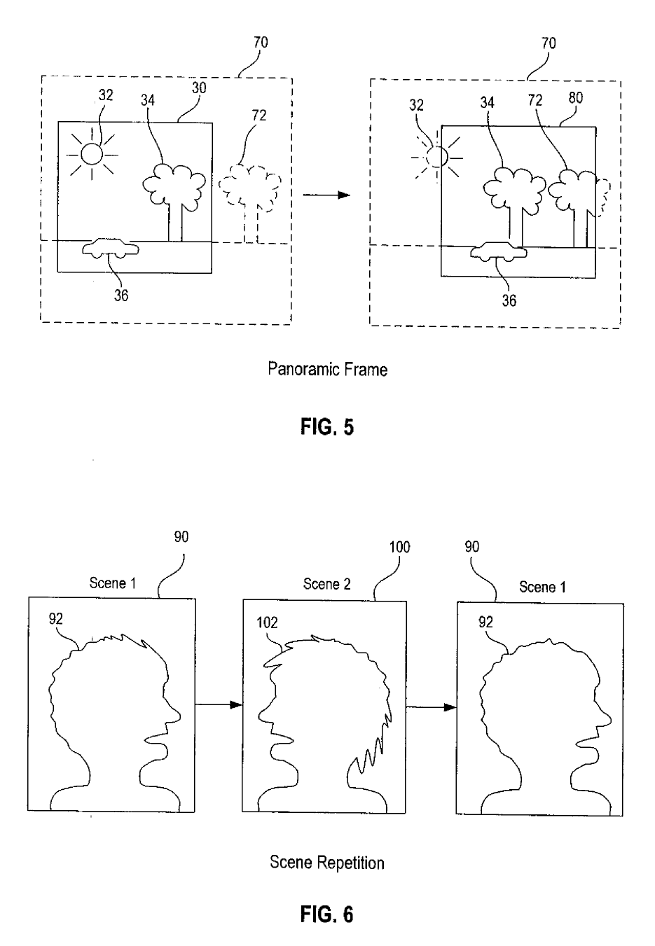

FIG. 5 illustrates the concept of panoramic frames according to an embodiment of the invention. Generally, a panoramic frame, or super frame, is a background scene with dimensions greater than a viewable frame or image that is actually displayed by the receiver. Because the boundaries of the panoramic frame extend beyond the boundaries of the viewable image, the viewable image can be thought of as a “window” within the panoramic frame. As a result, minor panning of the camera would be seen as movement of the “window” within the panoramic frame.

For example, a panoramic frame 70 may be stored in a background buffer in both the transmitter and the receiver. The viewable image 30 in FIG. 5 is similar to the image 30 in FIG. 3. However, the viewable image 30 in FIG. 5 is only a portion of the larger panoramic frame 70. Because the background of the viewable image 30 is already stored in the transmitter's background buffer as a portion of the panoramic frame 70, the transmitter does not need to re-send the entire background data of the viewable image to the receiver. Instead, the transmitter only needs to send a location of the viewable image 30 within the panoramic frame 70 to the receiver. Then the receiver may use the location data to retrieve from its background buffer the portion of the panoramic frame 70 corresponding to the background of the viewable image 30.

The objects 32, 34, 36 in the viewable image 30 in FIG. 5 may be treated similarly as the objects 32, 34, 36 in FIG. 3. As discussed above, the transmitter uses OCR to detect the objects 32, 34, 36 within the viewable image 30, and compares these objects to the objects stored in the transmitter's object buffer. In this example, because the panoramic frame 70 has already been stored in the transmitter's background buffer, each of the objects 32, 34, 36, 72 have similarly been stored in the transmitter's object buffer. As a result, the transmitter only needs to send the locations of the objects 32, 34, 36 to the receiver. Then the receiver may use the location data to retrieve the objects 32, 34, 36 from its object buffer and insert the objects at the appropriate locations within the viewable image 30.

Alternatively, the stationary objects 32, 34, 72 may be stored as part of the panoramic frame 70 itself, and thus be included in the background of the viewable images. In this way, the transmitter only needs to identify the moving objects (such as the automobile 36) separately from the background of the viewable images, and send the locations of the moving objects to the receiver.

When the transmitter captures a second viewable image 80, the transmitter compares the viewable image 80 to the panoramic frame 70 stored in the transmitter's background buffer. Because the background of the viewable image 80 matches a portion of the panoramic frame 70, the transmitter does not need to re-send the entire background data of the viewable image to the receiver. As a result, even though the backgrounds of the viewable images 30, 80 are different and represent movement of the camera, the transmitter only needs to send a new location of the viewable image 80 within the panoramic frame 70 to the receiver. The receiver may then use the new location data to retrieve from its background buffer the portion of the panoramic frame 70 corresponding to the background of the viewable image 80.

Again, each of the objects 32, 34, 36, 72 may already be stored in the object buffers of the transmitter and the receiver. However, because only a portion of the sun 32 and the tree 72 are visible in the viewable image 80, the transmitter may not recognize these objects and instead store them as new objects in the object buffer. In this case, the transmitter sends these portions of the sun 32 and the tree 72 in addition to the locations of the tree 34 and the automobile 36.

Alternatively, if the stationary objects 32, 34, 72 are stored as part of the panoramic frame 70 itself, then the portions of the sun 32 and the tree 72 are simply treated as part of the background of the viewable image 80. As a result, the transmitter only needs to send the new location of the automobile 36 to the receiver.

The panoramic frame 70 may be generated in a number of ways. For example, the panoramic frame 70 may be dynamic, and continually updated by the transmitter after each image is captured. In this case, the panoramic frame 70 begins in an initial temporary state, e.g., as a single image captured by the transmitter. As the transmitter continues to capture subsequent images, if a portion of the captured image matches a portion of the panoramic frame 70 but also includes an additional background portion not found in the panoramic frame, then the transmitter adds the new background portion of the captured image to the panoramic frame and stores the updated panoramic frame in the background buffer. In this way, the size, shape and content of the panoramic frame 70 may change as a function of the captured images. The panoramic frame 70 shown in FIG. 5 would then be the product of all of the relevant images captured by the transmitter prior to capturing the viewable image 30.

Alternatively, the panoramic frame 70 may be recorded by the transmitter all at once in anticipation of the images to be captured later by the transmitter. In this case, the panoramic frame 70 is constant, and subsequent images captured by the transmitter do not affect the panoramic frame. Thus, the panoramic frame 70 shown in FIG. 5 would not have been changed by any of the images captured by the transmitter prior to the viewable image 30.

For any given panoramic frame, one or more reference points may be chosen to indicate the position of the camera relative to the panoramic frame. Such a reference point allows the transmitter to measure the movement and direction of the camera as it pans within the panoramic frame. For example, the camera panning to the right within the panoramic frame would cause the reference point to appear to pan to the left. In this way, the reference point positions may be used to not only determine the position of the camera at any given point, but also to anticipate where the camera is going. This information may then be used to display the proper “window” within the panoramic frame, and update the “window” based on the movement of the camera.

The reference points themselves may be any relatively stationary object or icon within the panoramic frame. For example, these reference objects may be chosen by a director for their contrast and maintenance of visibility to the camera. Objects that reoccur in a given scene may also be downloaded and stored in memory in advance so that the camera may automatically identify the objects as reference points if a match is made in the image.

Alternatively, the reference points may also be invisible. For example, radio-frequency (RF) positioning devices may be used in the background of a scene. These RF devices may be hidden from view, and only detectible by the camera system. The camera system may then record the scene while recording synchronous position data from the RF devices.

A panoramic frame may be particularly useful in a video game environment. For example, a video game might have a single background scene, portions of which are displayed during the entire game. In this case, the entire background scene may be stored as a panoramic frame, and every “screen shot” during the game may be a viewable image within the panoramic frame. In addition, if the video game utilizes a predetermined library of objects and characters, then the library of objects and characters may be stored in the receiver's object buffer before the game begins. In this way, the transmitter does not need to send any of the objects and characters to the receiver. Instead, the transmitter may simply send an object identifier to the receiver so that the receiver may retrieve the corresponding object from the library stored in its object buffer. As a result, throughout the game, the transmitter may only need to send the locations of the viewable images within the panoramic frame, the object identifiers, and the locations and orientations of the objects.

FIG. 6 illustrates the concept of scene repetition according to an embodiment of the invention. Many video sequences involve a repetition of multiple scenes or background images. However, instead of the same scene being repeated consecutively, either a pattern of different scenes is repeated or the same scene is repeated non-consecutively.

For example, a repetition of a dual scene may be when two people 92, 102 are talking and the camera angle switches back and forth between two images 90, 100, where each image has a different background. After the transmitter captures the image 90 and then the image 100 for the first time, the backgrounds of both images are stored in a background buffer in both the transmitter and the receiver. In addition, the objects 92, 102 are detected and stored in an object buffer in both the transmitter and the receiver.

When the transmitter captures the image 90 for the second time, the transmitter compares the background of the image 90 to the backgrounds stored in the transmitter's background buffer. Because the background of the image 90 matches the same background already saved from the first time the transmitter captured the image 90, the transmitter recognizes that the image 90 has been repeated and does not need to re-send the entire background of the image to the receiver. As a result, even though the backgrounds of the images 100, 90 are different and represent a change between entirely different scenes, the transmitter only needs to indicate to the receiver that a previous background is being repeated.

Alternatively, instead of the transmitter saving the backgrounds of the images 90, 100 as separate backgrounds, the transmitter may combine the backgrounds into a single panoramic frame. For example, the backgrounds of the images 90, 100 may be treated as different viewable images within the same panoramic frame. In this case, no matter how many times the backgrounds of the images 90, 100 are repeated, the transmitter only needs to send the location of one of two viewable images within the same panoramic frame.

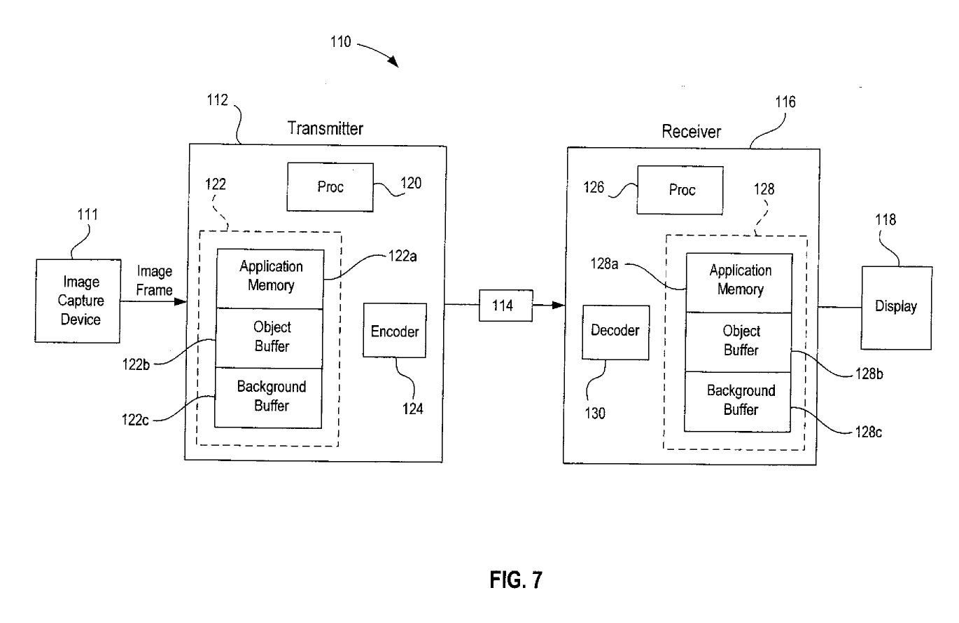

FIG. 7 is a block diagram of a system 110 according to an embodiment of the invention. The system 110 includes a transmitter 112, a network 114, a receiver 116, and an optional display 118.

The transmitter 112 includes a processor 120, a memory 122, and an optional encoder 124. The transmitter 112 captures or receives images from a camera or any other image source. Then the processor 120 processes the image utilizing any of the concepts described above. The applications or instructions executed by the processor 120 are stored in an application memory 122a. The memory 122 may also include one or more memory buffers 122b and 122c. The memory 122 may be any type of digital storage. For example, the memory 122 may include semiconductor memory, magnetic storage, optical storage, and solid-state storage.

Because some objects may appear in front of others in an image, the objects in the image may be organized by priority. As a result, the transmitter 112 may have multiple memory buffers, where the memory buffers have a hierarchy. For example, the transmitter 112 may have two memory buffers, where one of the memory buffers 122b is used as an object buffer and the other memory buffer 122c is used to store background information. In this case, the objects in the object buffer 122b have a higher priority than the background information in the background buffer 122c so that the objects always appear in front of the background in the images. Alternatively, the transmitter 112 may have multiple object buffers and multiple background buffers, so that each image is divided into multiple layers of objects and multiple layers of backgrounds. In this case, the priority of an object or background layer depends on its relative position along the z-axis of the image.

The transmitter 112 may also include an encoder 124 for encoding the images prior to transmitting the images to the receiver 116. The encoder 124 may utilize any type of video compression format, including an MPEG format similar to that described above. Alternatively, the transmitter 112 may not include any encoder at all if no compression format is utilized.

The transmitter 112 then sends the image data to the receiver 116 through the network 114. The network 114 may be any type of data connection between the transmitter 112 and the receiver 116, including a cable, the internet, a wireless channel, or a satellite connection.

The receiver 116 includes a processor 126, a memory 128, and an optional decoder 130. The receiver 116 receives the image data transmitted by the transmitter 112, and operates together with the transmitter to reproduce the images captured by the transmitter. As a result, the structure of the receiver 116 corresponds, in part, to the structure of the transmitter 112. For example, if the transmitter's memory 122 includes an application memory 122a, an object buffer 122b, and a background buffer 122c, then the receiver's memory 128 may similarly include an application memory 128a, an object buffer 128b, and a background buffer 128c. In addition, if the transmitter 112 includes an encoder 124 to encode the image data, then the receiver 116 may similarly include a decoder 130 to decode the image data from the transmitter.

The system 110 may also include a display 118 coupled to the receiver 116 for displaying the images. In this case, the receiver 116 may either be separate from the display 118 (as shown in FIG. 7) or the receiver may be built into the display. The display 118 may be any type of display, including a CRT monitor, a projection screen, an LCD screen, or a plasma screen.

From the foregoing it will be appreciated that, although specific embodiments of the invention have been described herein for purposes of illustration, various modifications may be made without deviating from the spirit and scope of the invention. For example, each of the described concepts may be used in combination with any of the other concepts when reproducing an image.

1.-25. (canceled)

26. An image encoder and a receiver, comprising:
one or more processors that operate to:
capture a first frame of pixel data that represents a first image of a video;
identify, with optical character recognition (OCR), objects in the first image;
capture a second frame of pixel data that represents a second image of the video;
identify, with the OCR, objects in the second image;
compare the objects in the second image with the objects in the first image to determine matching objects that are stationary and matching objects that are moving; and
encode the second image without encoding the matching objects that are stationary and the matching objects that are moving.

27. The image encoder and the receiver of claim 26, wherein the one or more processors further operate to:
reduce bandwidth between the image encoder and the receiver by sending the receiver the second image with no value for portions of the second image that have the matching objects that are stationary and the matching objects that are moving.

28. The image encoder and the receiver of claim 26, wherein the one or more processors further operate to:
send, from the image encoder to the receiver, a motion vector of the matching objects that are moving.

29. The image encoder and the receiver of claim 26, wherein the one or more processors further operate to:
determine an orientation and a location of the objects in the first image;
determine an orientation and a location of the objects in the second image;
compare the orientation and the location of the objects in the first image with the orientation and the location of the objects in the second image to determine the matching objects that are stationary and the matching objects that are moving.

30. The image encoder and the receiver of claim 26, wherein the one or more processors further operate to:
encode an entirety of the first image and send encoded data of the entirety of the first image to the receiver;
encode only a portion of the second image and send encoded data of only the portion of the second image to the receiver.

31. The image encoder and the receiver of claim 26, wherein the one or more processors further operate to:
store new objects discovered in the second image without storing the matching objects that are stationary appearing in both the first image and the second image.

32. The image encoder and the receiver of claim 26, wherein the encoder and the receiver use location data corresponding to the objects in the first and second images to eliminate sending motion vectors from the encoder to the receiver.

33. The image encoder and the receiver of claim 26, wherein the one or more processors further operate to:
determine differences in an object from the first image to the second image and encode the differences as residuals on a per block basis within the object such that the image encoder only sends the residuals to the receiver instead of an entirety of the object.

34. The image encoder and receiver of claim 26, wherein the one or more processors further operate to:
detect an object in the first image;
determine that new portions are added to the object in the second image;
encode the new portions without encoding the object in the second image;
send, from the image encoder to the receiver, only the new portions of the object.

35. A system, comprising:
a transmitter that receives video images from an image capture device;
a receiver that receives encoded images from the transmitter; and
one or more processors that operate to:
perform optical character recognition (OCR) on the video images to identify objects in different frames of the video images;
compare the objects in the different frames of the video images to determine objects that change and objects that remain unchanged from one frame to another frame;
compress the video images by encoding the objects that change without encoding the objects that remain unchanged; and
transmit, from the transmitter to the receiver, encoded data of the objects that change without transmitting encoded data of the objects that remain unchanged.

36. A system, comprising:
a transmitter that receives video images from an image capture device;
a receiver that receives encoded images from the transmitter; and
one or more processors that operate to:
perform optical character recognition (OCR) on the video images to identify different objects in the video images;
compare objects in frames of the video images to determine objects that move and objects that are stationary;
divide a single OCR recognized object into a section that moves and a section that remains unchanged; and
limit both encoding by the transmitter and transmission of encoded data to the receiver by encoding and transmitting the section that moves without encoding and transmitting the section that remains unchanged.

37. The system of claim 36, wherein the single OCR recognized object is an automobile with wheels being the section that moves and doors being the section that remains unchanged.

38. A method executed by one or more processors in a video compression system, comprising:
capturing, by the video compression system, frames of pixel data that represents a series of images of a video;
identifying, by the video compression system and with optical character recognition (OCR), objects in series of images;
comparing, by the video compression system, the objects in the series of images to determine matching objects that are stationary and matching objects that are moving; and
encoding, by the video compression system, the matching objects that are moving without encoding the matching objects that are stationary.

39. The method of claim 38, further comprising:
transmitting, from an image encoder in the video compression system to a receiver in the video compression system, encoded data of the matching objects that are moving without transmitting encoded data of the matching objects that are stationary.

40. The method of claim 38, further comprising:
comparing location data of the objects and orientation data of the objects to determine the matching objects that are stationary and the matching objects that are moving.

41. The method of claim 38, further comprising:
reducing bandwidth between an image encoder and a receiver by sending the receiver the matching objects that are moving without sending the matching objects that are stationary.

42. A method executed by one or more processors in a video compression system, comprising:
receiving, by the video compression system, a first frame of pixel data that represents a first image of a video;
identifying, by the video compression system and with optical character recognition (OCR), objects in the first image;
receiving, by the video compression system, a second frame of pixel data that represents a second image of the video;
identifying, by the video compression system and with the OCR, objects in the second image;
comparing, by the video compression system, the objects in the second image with the objects in the first image to determine matching objects that change and matching objects that remain unchanged; and
encoding, by the video compression system, the second image without encoding the matching objects that change and the matching objects that remain unchanged.

43. The method of claim 42 further comprising:
reducing bandwidth exchanged between an image encoder and a receiver in the video compression system by sending the receiver the second image with no value for portions of the second image that have the matching objects that change and the matching objects that remain unchanged.

44. The method of claim 42 further comprising:
sending, from an image encoder to a receiver in the video compression system, a motion vector of the matching objects that change.

45. The method of claim 42 further comprising:
determining an orientation and a location of the objects in the first image;
determining an orientation and a location of the objects in the second image;
comparing the orientation and the location of the objects in the first image with the orientation and the location of the objects in the second image to determine the matching objects that change and the matching objects that remain unchanged.

46. The method of claim 42 further comprising:
discovering new objects in the second image that are not present in the first image;
storing the new objects without storing matching objects that are stationary and appear in both the first image and the second image.

47. The method of claim 42 further comprising:
eliminating sending motion vectors from an encoder to a receiver by determining location data corresponding to the objects in the first and second images.

48. The method of claim 42 further comprising:
determining differences of location in an object in the first image to the object in second image;
encoding these differences as residuals on a per block basis within the object such that an encoder only sends the residuals to a receiver instead of an entirety of the object.
